(19) United States
(12) Patent Application Publication
(10) Pub. No.: US 2005/0120224 A1
(43) Pub. Date: Jun. 2, 2005

(54) Communication system, communication terminal and server apparatus, and method used in communication system to authenticate connection

(75) Inventor: Hideto Murakami, Machida-shi (JP)

Correspondence Address: Finnegan, Henderson, Farabow,;Garrett & Dunner, L.L.P., 1300 I Street, N.W., Washington, DC, 20005-3315, US

(73) Assignee: KABUSHIKI KAISHA TOSHIBA

(21) Appl. No.: 10/969,188

(22) Filed: Oct. 21, 2004

(30) Foreign Application Priority Data
Nov. 28, 2003 (JP) 2003-400790

(51) Int. Cl. H04K 1/00

(52) U.S. Cl. 713/182

(57) ABSTRACT

A communication system includes a communication terminal and a server apparatus, the communication terminal includes an acquiring circuit acquires secret information in which at least one of a term of validity and the number of effective use times is determined, and a record the secret information in a first memory, a recorder records terminal identification information pre-assigned to the communication terminal, in the first memory, a reader reads the secret information and the terminal identification information from the first memory, a generator generates the authentication information, and a transmitter transmits the authentication information to the server apparatus via the communication network, and the server apparatus includes a recorder records the secret information issued to the communication terminal and the terminal identification information in a second memory, a determining circuit determines whether or not a user is valid, and a connector connects the server apparatus to the communication terminal.

### CROSS-REFERENCE TO RELATED APPLICATIONS

This application is based upon and claims the benefit of priority from prior Japanese Patent Application No. 2003-400790, filed Nov. 28, 2003, the entire contents of which are incorporated herein by reference.

### BACKGROUND OF THE INVENTION

1. Field of the Invention

The present invention relates to a communication system in which if a communication terminal is to connect to a server apparatus via a communication network, the connection is authenticated for the communication terminal, the communication terminal and server apparatus used in the communication system, and a method used in the communication system to authenticate a connection.

2. Description of the Related Art

In recent years, it has become popular to provide, in a communication system, data communication services using personal computers, cellular phones, or portable information terminals having radio communication functions.

For example, if a user is to acquire desired information from an information provider on the Internet, the user issues a call to the desired information provider from a communication terminal. Then, the information provider's server is accessed. Once a communication path is established between the communication terminal and the server, information corresponding to a request from the communication terminal is transmitted from the server to the communication terminal via the communication path.

Such data communication services are very convenient because they enable transmissions and receptions of e-mails and accesses to home pages or the like on the Internet.

Further, in the communication system, when the user desires an online purchase and performs a predetermined operation on the communication terminal, the user can access a purchase center (server) to execute a purchase procedure online.

Such a system usually executes a simple encrypting and authenticating processes. However, at present, the security of the Internet is not sufficient, so that invalid third people may alter authentication information on valid users.

Thus, onetime password systems such as the one described below (for example, Jpn. Pat. Appln. KOKAI Publication Nos. 2000-330944, 2002-259344, and 2001-357018) have been proposed. A one-way hush function is repeatedly applied n times to a combination of a key called a seed a pass phrase for each user which are delivered by a server apparatus. The resulting data is transmitted to and registered in the server apparatus. Whenever the user subsequently logs in the server apparatus, the user transmits the last transmitted hush functions minus one hush function (MDn-1) as a password. Then, a host applies the hush function once this password once to check it against the initially registered password. If the password is correct, the host authenticates it.

However, the onetime password system requires a password to be registered every specified number of times. Further, the registering operation must use a reliable communication path in order to prevent the leakage of the pass phrase. Accordingly, this system is not suitable for a network in which third people may interfere with communications.

### BRIEF SUMMARY OF THE INVENTION

It is thus an object of the present invention to provide a communication system which does not require a password to be manually inputted every time a connection is made to a server apparatus and which can provide a sufficient security function for information transmissions using a simple procedure, the communication terminal and server apparatus used in the communication system, and a method used in the communication system to authenticate a connection.

According to an aspect of the present invention, there is provided a communication system connecting a communication terminal and a server apparatus via a communication network, the communication terminal notifies the server apparatus of authentication information to utilize a communication service provided by the server apparatus, the communication terminal comprising: an acquiring circuit to acquire secret information in which at least one of a term of validity and the number of effective use times is determined, and record the secret information in a first memory; a recorder which records terminal identification information pre-assigned to the communication terminal, in the first memory; a reader which reads the secret information and the terminal identification information from the first memory, when the communication terminal is connected to the server apparatus; a generator which generates the authentication information by combining the secret information and the terminal identification information together; and a transmitter which transmits the authentication information to the server apparatus via the communication network, and the server apparatus comprising: a recorder which records the secret information issued to the communication terminal and the terminal identification information in a second memory; a determining circuit to determine whether or not a user is valid by comparing the authentication information with the secret information and terminal identification information; and a connector which connects the server apparatus to the communication terminal, when the user is determined to be valid based on a result of the determination.

According to another aspect of the present invention, there is provided a communication terminal adapted to connect a server apparatus via a communication network, notifying the server apparatus of authentication information to utilize a communication service provided by the server apparatus, the communication terminal comprising: an acquiring circuit to acquire secret information in which at least one of a term of validity and the number of effective use times is determined, and records the secret information in a memory; a recorder which records pre-assigned terminal identification information in the memory; a reader which reads the secret information and the terminal identification information from the memory, when the communication terminal is connected to the server apparatus; a generator which generates the authentication information by combining the secret information and the terminal identification information together; and a transmitter which transmits the authentication information to the server apparatus via the communication network.

According to yet another aspect of the present invention, there is provided a server apparatus used in a communication system connecting a communication terminal and the server apparatus via a communication network, the communication terminal notifies the server apparatus of authentication information to utilize a communication service provided by the server apparatus, the server apparatus comprising: a recorder which records the secret information issued to the communication terminal and the terminal identification information for the communication terminal in a memory; a determining circuit to determine whether or not a user is valid by comparing the authentication information transmitted by the communication terminal with the secret information and terminal identification information; and a connector which connects the server apparatus to the communication terminal, when the user is determined to be valid based on a result of the determination.

According to yet another aspect of the present invention, there is provided a method of authenticating a connection used in a communication system connecting a communication terminal and a server apparatus via a communication network, the communication terminal notifies the server apparatus of authentication information to utilize a communication service provided by the server apparatus, the method comprising: acquiring secret information in which at least one of a term of validity and the number of effective use times is determined, in the communication terminal; recording the secret information in a first memory, in the communication terminal; recording terminal identification information pre-assigned by the server apparatus, in the first memory, in the communication terminal; reading the secret information and the terminal identification information from the first memory, when the communication terminal is connected to the server apparatus; generating the authentication information by combining the secret information and the terminal identification information together; transmitting the authentication information to the server apparatus via the communication network; determining whether or not a user is valid by comparing the authentication information transmitted by the communication terminal with the held secret information and terminal identification information, in the server apparatus; and connecting the server apparatus to the communication terminal, when the user is determined to be valid based on a result of the determination.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the embodiments given below, serve to explain the principles of the invention.

FIG. 1 is a schematic view showing the configuration of a communication system according to a first embodiment of the present invention;

FIG. 2 is a block diagram showing the functional configuration of a client terminal and an authentication server both shown in FIG. 1;

FIG. 3 is a sequence diagram showing signal transmitting and receiving operations performed for authentication according to the first embodiment;

FIG. 4 is a sequence diagram showing signal transmitting and receiving operations performed when authentication fails according to the first embodiment;

FIG. 5 is a flow chart showing process operations performed by an authentication server according to the first embodiment;

FIG. 6 is a schematic view showing the configuration of a communication system according to a second embodiment of the present invention; and

FIG. 7 is a block diagram showing the functional configuration of a client terminal, an authentication server, and a challenge issuing server all shown in FIG. 6.

### DETAILED DESCRIPTION OF THE INVENTION

Embodiments of the present invention will be described below in detail with reference to the drawings.

### First Embodiment

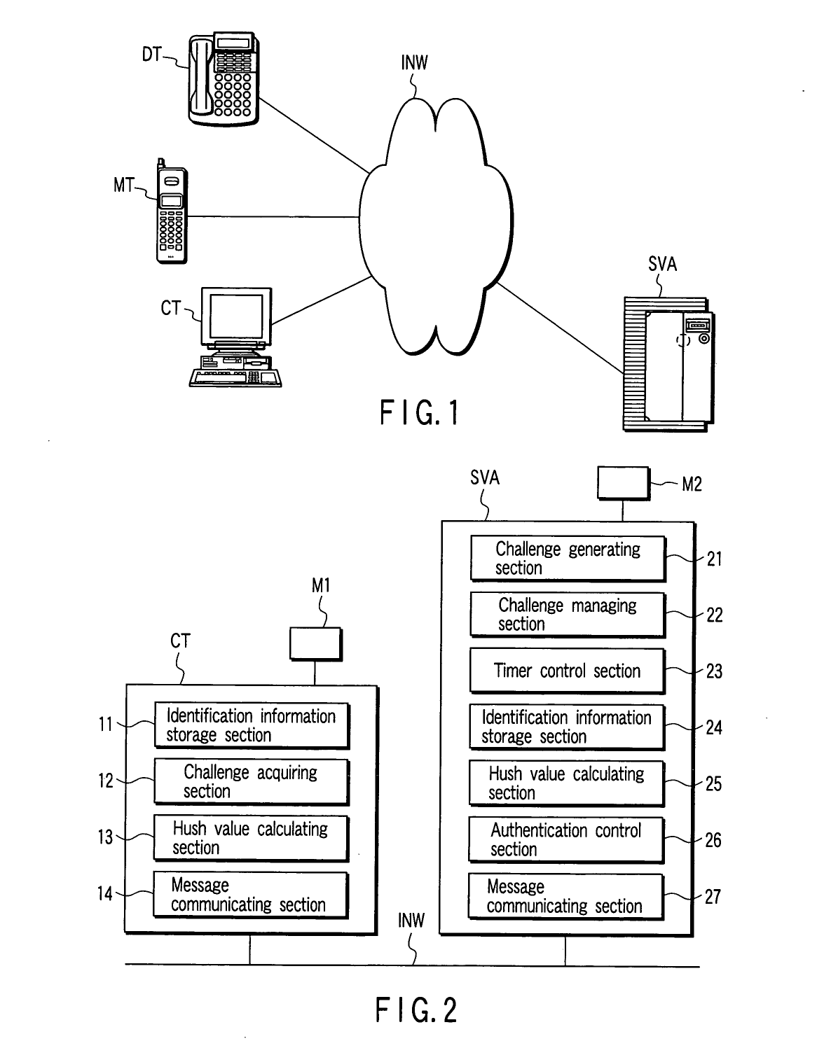

FIG. 1 is a schematic view showing the configuration of a communication system according to a first embodiment of the present invention. Reference characters DT and MT denote an IP (Internet Protocol) telephone terminal and a cellular phone terminal, respectively. Reference characters CT and SVA denote a client terminal composed of a personal computer and an authentication server, respectively.

The IP telephone terminal IP, the cellular phone terminal MT, and the client terminal CT are connected to a communication network INW such as the Internet or an intranet. The authentication server SVA is connected to the communication network INW. Thus, the IP telephone terminal IP, the cellular phone terminal MT, and the client terminal CT can also use the TCP/IP protocol to access the communication network INW. The authentication server SVA comprises a system managing function to execute an authenticating process, a billing process, and the like for the IP telephone terminal DT, the cellular phone terminal MT, and the client terminal CT. The authentication server SVA also has a function to download various pieces of information in response to a request from the IP telephone terminal DT, the cellular phone terminal MT, or the client terminal CT.

FIG. 2 is a block diagram showing the functional configuration of, for example, the client terminal and authentication server.

The client terminal CT comprises an identification information storage section 11, a challenge acquiring section 12, a hush value calculating section 13, and a message communicating section 14.

The identification information storage section 11 stores user identification information such as an IP address which is pre-assigned to the client terminal CT.

The challenge acquiring section 12 uses another means using a network to acquire a challenge string from the authentication server SVA and records the string in a memory M1. The challenge string is data for which an effective use period is set.

The hush value calculating section 13 combines the user identification information and challenge string stored in the identification information storage section 11 to generate authentication information. The hush value calculating section 13 then uses a one-way hush function to generate a message digest for the authentication information. An MD 5 (Message Digest #5) or the like is assumed to be used as a one-way hush function. The one-way hush function is characterized in that an input value cannot be derived from an output value and in that different input values are unlikely to generate the same output value.

When establishment of a TCP connection is requested, the message communicating section 14 first forms a connection on the communication network INW. If the connection has been correctly formed, the message communicating section 14 transmits an authentication request message to the authentication server SVA to using a provided message digest as a onetime password. The message communicating section 14 thus requests the authentication server SVA to authenticate the connection.

In the authentication request message, only a message type and the password are set and information required to identify the requesting terminal is not set. This makes it possible to avoid the risk of leakage of the user identification information.

On the other hand, the authentication server SVA comprises a challenge generating section 21, a challenge managing section 22, a timer control section 23, an identification information storage section 24, a hush value calculating section 25, an authentication control section 26, and a message communicating section 27.

The challenge generating section 21 uses random numbers or the like to newly generate an irregular challenge string. The challenge generating section 21 then notifies the challenge managing section 22 of the generated challenge string.

The challenge managing section 22 stores the generated challenge string on a memory M2. The challenge managing section 22 then requests the timer control section 23 to activate a term of validity timer in order to manage the term of validity.

The challenge string is deleted from the authentication server SVA when the term of validity expires. No new challenge string is generated until a new acquisition request is made.

The timer control section 23 activates a timer corresponding to the prespecified term of validity.

The identification information storage section 24 pre-stores the user identification information on the client terminal CT.

The hush value calculating section 25 generates a message digest using the same method as that used in the client terminal CT.

The authentication control section 26 compares the message digest generated by the hush value calculating section 25 with the message digest notified of by the client terminal CT. If the message digests have the same value, the authentication control section 26 utilizes the message communicating section 27 to notify the client terminal CT that the connection has been successfully authenticated. The authentication control section 26 thus completes the authenticating operation.

On the other hand, if the message digests do not match, the authentication control section 26 determines that the authentication has failed. The authentication control section 26 then uses the message communicating section 27 to remove the established connection.

Now, description will be given of process operations performed by the system configured as described above.

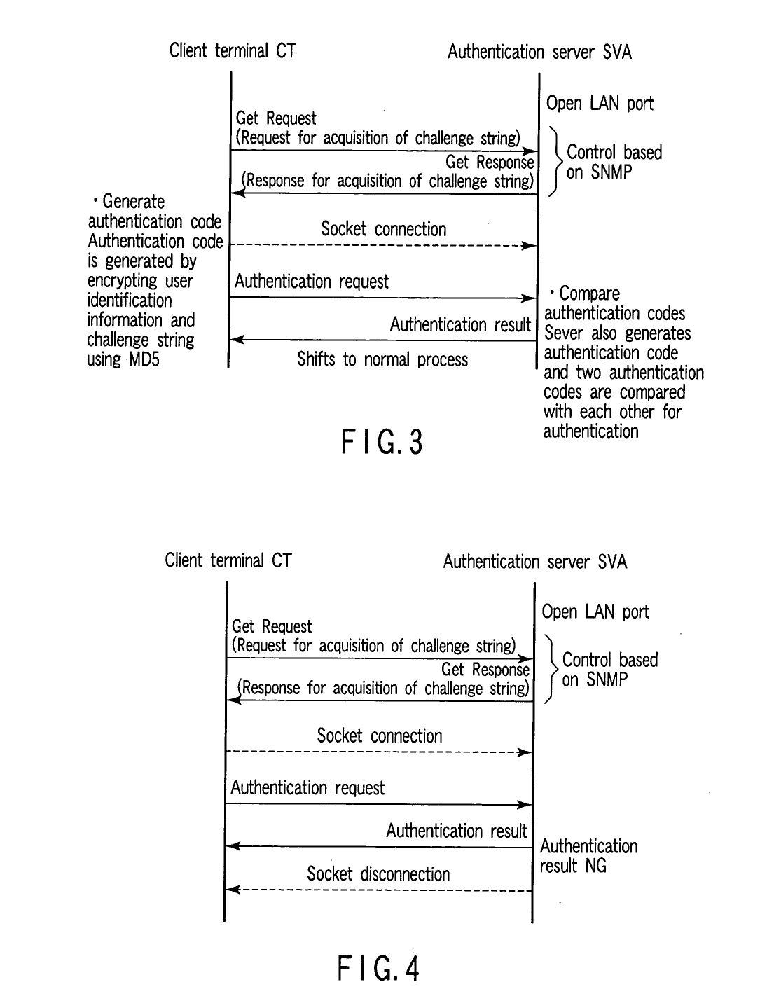

FIG. 3 is a sequence diagram showing signal transmitting and receiving operations performed for authentication. FIG. 4 is a sequence diagram showing signal transmitting and receiving operations performed when authentication fails.

First, the challenge acquiring section 12 of the client terminal CT requests the message transmitting and receiving section 14 to acquire a challenge string for a prespecified MIB from the authentication server SVA.

The message communicating section 14 uses a specified circuit I/F and a specified protocol to dispatch a message (a Get Request in FIG. 3) to the communication network INW.

The message communicating section 27 of the authentication server SVA checks the protocol and contents of the message transmitted by the communication network INW. If the message has been confirmed to be a challenge acquisition request (a request in accordance with SNMP (Simple Network management Protocol)), the message communicating section 27 notifies the challenge managing section 22 of this.

The challenge managing section 22 of the authentication server SVA checks whether or not there is any already generated challenge string on a recording medium. If there is no challenge string, the challenge managing section 22 requests the challenge generating section 21 to generate a challenge string.

In the description of this embodiment, the whole system uses only one challenge string. However, a challenge string may be generated and managed for each source IP address contained in an IP packet transmitted by the terminal requesting a challenge string (in this case, the client terminal CT). In this case, the challenge varies with the challenge requesting terminals. It is thus possible to expect further improved security.

If there is already a challenge string, challenge generating section 21 does not generate any challenge string but request the timer control section 23 to prolong the time set in the term of validity timer.

The challenge generating section 21 uses random numbers or the like to newly generate an irregular challenge string. The challenge generating section 21 then returns the generated challenge string to the challenge managing section 22.

The challenge managing section 22 stores the generated challenge string on the memory M2. The challenge managing section 22 then requests the timer control section 23 to activate the term of validity timer in order to manage the term of validity.

The challenge string is deleted from the authentication server SVA when the term of validity expires. No new challenge string is generated until a new acquisition request is made.

The timer control section 23 activates the timer corresponding to the prespecified term of validity.

The authentication server SVA thus completes generating a challenge string. In response to a challenge get request (Get Request) from the client terminal CT, the generated challenge string is transmitted to the client terminal CT.

The challenge acquiring section 12 of the client terminal CT notifies the hush value calculating section 13 of the challenge string acquired. The hush value calculating section 13 couples the user identification information stored in the identification information storage section 11 to the challenge string acquired, to generate a new string. The user identification information may be embedded in software or may be generated. This sharply reduces the possibility of leakage of the user identification information embedded in the software in the client terminal CT (leakage may occur only when reverse engineering is used).

The hush value calculating section 13 uses this string as an input to generate a message digest using a one-way hush function.

After generating a message digest, the hush value calculating section 13 requests the message communicating section 14 to establish a TCP (Transmission Control Protocol) connection to the authentication server SVA. At this time, the hush value calculating section 13 also notifies the message communicating section 14 of the generated message digest.

When establishment of a TCP connection is requested, the message communicating section 14 of the client terminal CT first forms a connection on the specified communication network INW.

If the connection has been correctly formed, the message communicating section 14 transmits an authentication request message to the authentication server SVA to using the provided message digest as a onetime password. The message communicating section 14 thus requests the authentication server SVA to authenticate the connection.

When establishment of a TCP connection is requested, the message communicating section 27 of the authentication server SVA establishes the connection without making particular regulations.

If an authentication request is the first message received by the message communicating section 27 of the authentication server SVA after the connection to the client terminal CT has been established, the authentication control section 26 is notified that an authenticating operation has been requested. In this case, if the first message received after the establishment of the connection is not an authentication request, an operation is performed in accordance with prespecified contents (for example, the connection is removed, or the connection remains active until the specified number of connections or a specified time is reached).

The authentication control section 26 inquires of the challenge managing section 22 as to whether or not there is any generated challenge string. If there is no challenge string, the authentication control section 26 determines that the request is erroneous. The authentication control section 26 then requests the message communicating section 27 to remove the connection.

If the result of the inquiry indicates that there is a challenge string, the authentication control section 26 acquires the recorded user identification information from the user identification information storage section 24. The authentication control section 26 then couples the user identification information to the challenge string and requests the hush value calculating section 25 to generate a message digest.

The authentication control section 26 compares the message digest generated by the hush value calculating section 25 with the message digest notified of by the client terminal CT. If the message digests have the same value, the authentication control section 26 utilizes the message communicating section 27 to notify the client terminal CT that the connection has been successfully authenticated. The authentication control section 26 thus completes the authenticating operation.

On the other hand, if the message digests do not match, then as shown in FIG. 4, the authentication control section 26 determines that the authentication has failed, and then uses the message communicating section 27 to remove the established connection.

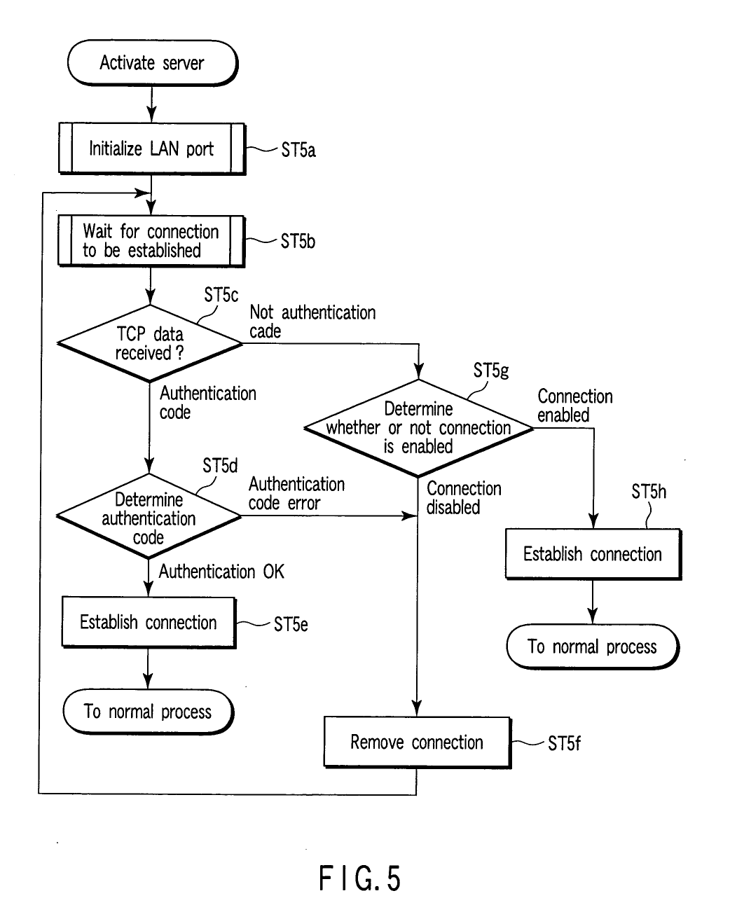

FIG. 5 is a flow chart showing process operations performed by an authentication server SVA.

First, when powered on, the authentication server SVA initializes a LAN port (step ST5a). For example, the authentication server SVA waits for the connection to the client terminal CT to be established (step ST5c) and determines whether or not to receive TCP data from the client terminal CT (step ST5c). If the received TCP data is an authentication code, the authentication server SVA determines whether or not the user is valid, based on its owned user identification information and challenge string (step ST5d). If the authentication server SVA determines that the user is valid (authentication OK), it establishes a connection to the client terminal CT (step ST5e). The procedure then shifts to a normal process.

On the other hand, if the authentication results in an error, the authentication server SVA removes the connection to the client terminal CT.

Further, in the step ST5c, if the TCP data is not an authentication code, the authentication server SVA determines whether or not the connection is possible (step ST5g). If the connection is possible, the authentication server SVA establishes a connection to the client terminal CT (step ST5h). The procedure then shifts to a normal process.

On the other hand, if the connection is impossible, the authentication server SVA removes the connection to the client terminal CT.

As described above, in the first embodiment, the client terminal CT acquires a challenge string for which the term of validity is determined and stores it in the memory M1. When the client terminal CT is to connect to the authentication server SVA, the client terminal CT combines together the challenge string recorded in the memory M1 and the terminal identification information stored in the identification information storage section 11. The client terminal CT then transmits the authentication information to the authentication server SVA via the communication network INW. Further, before establishing a connection to the client terminal CT, the authentication server SVA determines whether or not the user is valid, on the basis of authentication information transmitted by the client terminal CT. Then, the authentication server SVA establishes the connection if the user is valid.

Accordingly, provided that the term of validity remains effective, the user need not manually set or register a challenge string. Further, the system does not require any new hardware, is inexpensive, and further improves security.

Furthermore, in the first embodiment, in response to an acquisition request transmitted by the client terminal ST, the authentication server SVA generates and transfers a challenge string to the client terminal CT via the communication network INW. The challenge string is then stored in the memory M1 in the client terminal CT. This enables the challenge string to be quickly and efficiently transmitted to the client terminal CT. Accordingly, the client terminal CT can instantaneously acquire the new challenge string.

### Second Embodiment

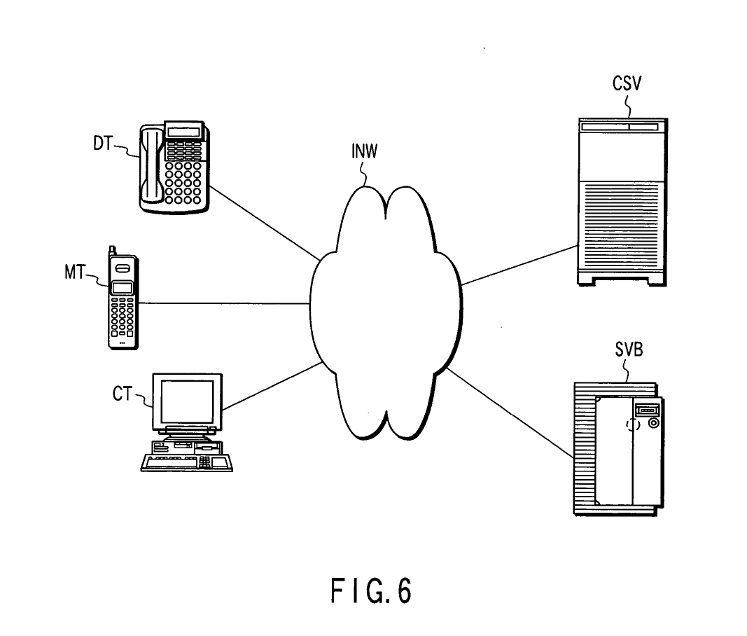

FIG. 6 is a schematic view showing the configuration of a communication system according to a second embodiment of the present invention. A challenge issuing server CSV is connected to the communication network INW.

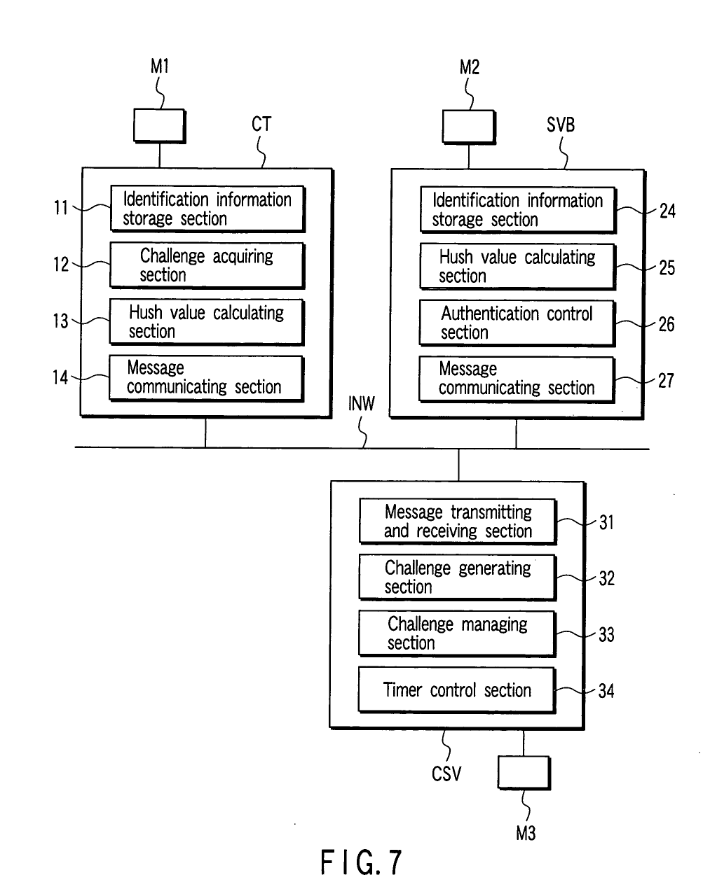

FIG. 7 is a block diagram showing the functional configuration of the client terminal CT, the authentication server SVB, and the challenge issuing server CSV. In FIG. 7, the same parts as those in FIG. 2 are denoted by the same reference numerals, with their detailed description omitted.

The challenge issuing server CSV comprises a message transmitting and receiving section 31, a challenge generating section 32, a challenge managing section 33, and a timer control section 34 as some of the functions to be possessed by the authentication server.

Description will be given below of process operations performed by this configuration.

The identification information storage section 24 of an authentication server SVB pre-stores user identification information on the client terminal CT to be connected to the authentication server SVB.

Before requesting the authentication server SVB to execute authentication, the client terminal CT allows the challenge acquiring section 12 to acquire a challenge string from the challenge issuing server CSV using any means that uses the communication network INW. Description will be given below of operations performed to acquire a keyword using the SNMP.

First, the challenge acquiring section 12 of the client terminal CT requests the message communicating section 14 to acquire a challenge string for a prespecified MIB from the authentication server SVB.

The message communicating section 14 uses a specified circuit I/F and a specified protocol to dispatch a message to the network.

The challenge managing section 33 of the challenge generating server CSV checks whether or not there is any already generated challenge string in a memory M3. If there is no challenge string, the challenge managing section 33 requests the challenge generating section 32 to generate a challenge string. If there is already a challenge string, challenge generating section 32 does not generate any challenge string but request the timer control section 34 to prolong the time set in the term of validity timer.

The challenge generating section 32 uses random numbers or the like to newly generate an irregular challenge string. The challenge generating section 32 then returns the generated challenge string to the challenge managing section 33.

The challenge managing section 33 stores the generated challenge string on the memory M3. The challenge managing section 33 then requests the timer control section 34 to activate the term of validity timer in order to manage the term of validity. The challenge string is deleted from the memory M3 when the term of validity expires. No new challenge string is generated until a new acquisition request is made.

The timer control section 34 activates the timer corresponding to the prespecified term of validity.

The challenge generating server CSV thus completes generating a challenge string. In response to a challenge get request (Get Request) from the client terminal CT, the generated challenge string is transmitted to the client terminal CT.

The challenge acquiring section 12 of the client terminal CT notifies the hush value calculating section 13 of the challenge string acquired. The hush value calculating section 13 couples the user identification information stored in the identification information storage section 11 to the challenge string acquired, to generate a new string.

The hush value calculating section 13 uses this string as an input to generate a message digest using a one-way hush function.

After generating a message digest, the hush value calculating section 13 of the client terminal CT requests the message communicating section 14 to establish a TCP connection to the authentication server SVB. At this time, the hush value calculating section 13 also notifies the message communicating section 14 of the generated message digest.

When establishment of a TCP connection is requested, the message communicating section 14 of the client terminal CT first forms a connection on the specified communication network INW.

If the connection has been correctly formed, the message communicating section 14 transmits an authentication request message to the authentication server SVB to using the provided message digest as a onetime password. The message communicating section 14 thus requests the authentication server SVB to authenticate the connection.

When establishment of a TCP connection is requested, the message communicating section 27 of the authentication server SVB establishes the connection without making particular regulations.

If an authentication request is the first message received by the message communicating section 27 of the authentication server SVB after the connection to the client terminal CT has been established, the authentication control section 26 is notified that an authenticating operation has been requested.

If the first message received after the establishment of the connection is not an authentication request, an operation is performed in accordance with prespecified contents (for example, the connection is removed, or the connection remains active until the specified number of connections or a specified time is reached).

The authentication control section 26 uses the message communicating section 27 to inquires of the challenge generating server CSV, via the network, as to whether or not there is any generated challenge string.

The challenge managing section 33 of the challenge generating sever CSV determines whether or not there is any challenge string in the memory M3. As a result, if there is any challenge string, the challenge managing section 33 notifies the authentication control section 26 of the corresponding challenge string. If there is no challenge string, the challenge managing section 33 notifies the authentication control section 26 that there is no challenge string. If the result of the inquiry indicates that there is a challenge string, the authentication control section 26 of the authentication server SVB acquires the recorded user identification information from the user identification information storage section 24. The authentication control section 26 then couples the user identification information to the challenge string and requests the hush value calculating section 25 to generate a message digest.

The hush value calculating section 25 generates a message digest using the same method as that used in the client terminal CT.

The authentication control section 26 compares the message digest generated by the hush value calculating section 25 with the message digest notified of by the client terminal CT. If the message digests have the same value, the authentication control section 26 utilizes the message communicating section 27 to notify the client terminal CT that the connection has been successfully authenticated. The authentication control section 26 thus completes the authenticating operation.

On the other hand, if the message digests do not match, the authentication control section 26 determines that the authentication has failed. The authentication control section 26 then uses the message communicating section 27 to remove the established connection.

As described above, in the second embodiment, the challenge issuing server CSV generates and communicates a challenge string. This saves the authentication server SVB the load of the process of generating and communicating a challenge string compared to the first embodiment.

Further, the challenge generating section 32 and the authentication control section 26 are distributed between the authentication server SVB and the challenge issuing server CSV. This further reduces the risk of eavesdropping on the communication network INW.

### Other Embodiments

The present invention is not limited to the above embodiments. For example, in the above described examples of the embodiments, a challenge string for which the term of validity is determined is acquired. However, the present invention is not limited to this. It is allowable to acquire a challenge string for which the number of times the string can be effectively used is determined.

Further, in the above described examples of the embodiments, the client terminal transmits a request for acquisition of a challenge request to the authentication server or challenge issuing server and stores, in the memory, a challenge string transmitted by the authentication server or challenge issuing server in response to the acquisition request. However, the present invention is not limited to this aspect. The authentication server or challenge issuing server may record a challenge string on a portable recording medium such as a magnetic disk or an optical disk, which is then sent to the client terminal by mail. The client terminal may then read the challenge string from the portable recording medium and records it in the memory. This eliminates the need to construct a new infrastructure for communicating a challenge string. Therefore, the system can be implemented inexpensively and safely.

Moreover, in the above embodiment, the authenticating process is executed between the client terminal and the authentication server or challenge issuing server. However, the authenticating process may be executed between the client terminal and an IP telephone terminal or cellular phone terminal.

Furthermore, many variations may be made to the configuration and type of the system, the configuration and type of a server apparatus such as an authentication server, the configuration and type of a telephone terminal such as a client terminal, the authenticating process procedure, and the like without departing from the spirits of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A communication system connecting a communication terminal and a server apparatus via a communication network, the communication terminal notifies the server apparatus of authentication information to utilize a communication service provided by the server apparatus,
the communication terminal comprising:
an acquiring circuit to acquire secret information in which at least one of a term of validity and the number of effective use times is determined, and record the secret information in a first memory;
a recorder which records terminal identification information pre-assigned to the communication terminal, in the first memory;
a reader which reads the secret information and the terminal identification information from the first memory, when the communication terminal is connected to the server apparatus;
a generator which generates the authentication information by combining the secret information and the terminal identification information together; and
a transmitter which transmits the authentication information to the server apparatus via the communication network, and
the server apparatus comprising:
a recorder which records the secret information issued to the communication terminal and the terminal identification information in a second memory;
a determining circuit to determine whether or not a user is valid by comparing the authentication information with the secret information and terminal identification information; and
a connector which connects the server apparatus to the communication terminal, when the user is determined to be valid based on a result of the determination.

2. The communication system according to claim 1, wherein the server apparatus comprises a notifying circuit to generate the secret information and communicate the secret information to the communication terminal.

3. The communication system according to claim 1, further comprising an issuing server apparatus which generates and communicates the secret information to the communication terminal.

4. The communication system according to claim 2, wherein the notifying circuit records the secret information in a portable memory, and the acquiring circuit reads the secret information from the portable memory and records the secret information in the first memory.

5. The communication system according to claim 1, wherein the acquiring circuit transmits a request for acquisition of the secret information from the communication terminal to the server apparatus, and records the secret information transmitted by the server apparatus in response to the acquisition request, in the first memory.

6. The communication system according to claim 2, wherein the issuing server apparatus records the secret information in the portable memory, and
the acquiring circuit reads the secret information from the portable memory and records the secret information in the first memory.

7. The communication system according to claim 3, wherein the acquiring circuit transmits a request for acquisition of the secret information from the communication terminal to the issuing server apparatus, and records the secret information transmitted by the issuing server apparatus in response to the acquisition request, in the first memory.

8. The communication system according to claim 1, wherein the secret information includes information different from communication terminals respectively.

9. A communication terminal adapted to connect a server apparatus via a communication network, notifying the server apparatus of authentication information to utilize a communication service provided by the server apparatus, the communication terminal comprising:
an acquiring circuit to acquire secret information in which at least one of a term of validity and the number of effective use times is determined, and records the secret information in a memory;
a recorder which records pre-assigned terminal identification information in the memory;
a reader which reads the secret information and the terminal identification information from the memory, when the communication terminal is connected to the server apparatus;
a generator which generates the authentication information by combining the secret information and the terminal identification information together; and
a transmitter which transmits the authentication information to the server apparatus via the communication network.

10. A server apparatus used in a communication system connecting a communication terminal and the server apparatus via a communication network, the communication terminal notifies the server apparatus of authentication information to utilize a communication service provided by the server apparatus, the server apparatus comprising:
a recorder which records the secret information issued to the communication terminal and the terminal identification information for the communication terminal in a memory;
a determining circuit to determine whether or not a user is valid by comparing the authentication information transmitted by the communication terminal with the secret information and terminal identification information; and
a connector which connects the server apparatus to the communication terminal, when the user is determined to be valid based on a result of the determination.

11. A method of authenticating a connection used in a communication system connecting a communication terminal and a server apparatus via a communication network, the communication terminal notifies the server apparatus of authentication information to utilize a communication service provided by the server apparatus, the method comprising:
acquiring secret information in which at least one of a term of validity and the number of effective use times is determined, in the communication terminal;
recording the secret information in a first memory, in the communication terminal;
recording terminal identification information pre-assigned by the server apparatus, in the first memory, in the communication terminal;
reading the secret information and the terminal identification information from the first memory, when the communication terminal is connected to the server apparatus;
generating the authentication information by combining the secret information and the terminal identification information together;
transmitting the authentication information to the server apparatus via the communication network;
determining whether or not a user is valid by comparing the authentication information transmitted by the communication terminal with the held secret information and terminal identification information, in the server apparatus; and
connecting the server apparatus to the communication terminal, when the user is determined to be valid based on a result of the determination.
